(19) United States
(12) Patent Application Publication
(10) Pub. No.: US 2022/0186913 A1
(43) Pub. Date: Jun. 16, 2022

(54) LIGHT COVER AND INSTALLATION TOOL AND METHOD

(71) Applicant: Edward Reed, White City (CA)

(72) Inventor: Edward Reed, White City (CA)

(21) Appl. No.: 17/548,338

(22) Filed: Dec. 10, 2021

Related U.S. Application Data
(60) Provisional application No. 63/125,252, filed on Dec. 14, 2020.

(51) Int. Cl. F21V 17/00; F21V 9/08; F21V 17/04; B25B 9/00

(52) U.S. Cl. CPC F21V 17/002; F21V 9/08; F21Y 2115/10; B25B 9/00; F21V 17/04

(57) ABSTRACT

A tool for installing and/or removing covers for light bulbs within a fixture is described. The tool may have a tube-shaped body with an installation end, a removal end, and a central axis along the tube-shaped body. A platform may be located within the tube-shaped body near the installation end. One or more frictional elements on an interior surface of the removal end may engage the cover. A handle attachment may be selectably and rotatably coupled to an exterior of the tube-shaped body between the installation end and the removal end.

### PRIORITY APPLICATION

This application claims priority to U.S. Provisional App. No. 63/125,252, filed on Dec. 14, 2020, herein explicitly incorporated by reference in its entirety.

### FIELD

This invention is in the field of covers for light bulbs and more specifically to tools for installing and/or removing the covers.

### BACKGROUND

Festive decorating of homes and businesses has included colored lights, most commonly Christmas lights. Soffit lights in the form of BR30 pot lights have become a common place for colored bulbs. To change the bulbs to festive colored bulbs, one would use a ladder, which may cause injury or inconvenience. Another method to change the bulb was a special device on the end of pole, which was prone to damaging the fixture by twisting the bulbs in and out in a rougher manner than that by hand.

In the last decade, LED type bulbs have become very popular and we are seeing less of incandescent bulbs. During this transition, it seems that the manufacturing of the colored BR30 bulbs has ceased, however, other shaped color bulbs are still available. Manufactures have replaced the colored bulbs with light & color-changing LED bulbs controlled by Wi-Fi at a much higher cost to the consumer and some have negative issues in colder weather.

Color light filters have been marketed using mechanical attaching accessories with drawbacks during the installation. Magnetic attaching of accessories had potential but only work on metal light fixtures.

LED light type bulbs generate very little heat compared to the traditional incandescent type of bulb thus allowing the introduction to use plastic tight against the bulb. Some manufacturers use plastic for the housing instead of glass.

### SUMMARY

The invention comprises the aspects described herein in any and/or all combinations.

According to an aspect there is provided a tool for installing a cover for a light bulb within a fixture. The tool may have a tube-shaped body with an installation end and a central axis; a platform located within the tube-shaped body approximately a height of the cover from the installation end; and/or a handle attachment located near an opposite end of the installation end; the handle attachment may receive an extension pole. The platform may be contoured to a shape of the cover. The tube-shaped body may have a thickness sized so that the installation end fits between the light bulb and the fixture. A diameter of the installation end may be approximately 110% of a largest diameter of a light emitting end of the light bulb. The central axis of the tube-shaped body may be aligned with an axis of the light bulb; and the installation end may be pushed upward toward the light bulb until a cuff of the cover bypasses the largest diameter of the light bulb. An interior storage may be within the tube-shaped body.

According to another aspect, the installing tool may further comprise a pair of pivots on opposite sides of the tube-shaped body with an axis transverse to the central axis of the tube-shaped body; the pair of the pivots may receive a pair of rods extending generally parallel to the tube-shaped body and may couple to the handle attachment. Each of the rods may have a bend and an angled portion with the angled portion approaching the central axis of the tube-shaped body; and the angled portions couple to the handle attachment. The handle attachment may be generally aligned with the central axis of the tube-shaped body.

According to another aspect, the installing tool may further comprising a removal end opposite to the installation end. The removal end may comprise at least one frictional element on an interior surface of the removal end for engaging the cover. The at least one frictional element may be selected from at least one of: at least one arm, at least one wedge, at least one elastic, and any combination of the at least one arm, the at least one wedge, and the at least one elastic.

According to another aspect, there is provided a tool for removing a cover from a light bulb within a fixture, The tool may have a tube-shaped body with an removal end and a central axis; at least one frictional element on an interior surface of the removal end for engaging the cover; and a handle attachment located near an opposite end of the removal end; the handle attachment may receive an extension pole. An interior storage may be within the tube-shaped body; and the interior storage may receive at least one of the covers from the removal end. A cutout may extend from an exterior of the tube-shaped body to the interior storage; and the cutout may be sized to allow passage of the cover therethrough. The at least one frictional element may be selected from at least one of: at least one arm, at least one wedge, at least one elastic, and any combination of the at least one arm, the at least one wedge, and the at least one elastic. The at least one frictional element may be integrally formed with the tube-shaped body.

The at least one arm may be angled downward away from the removal end and along an interior wall of the tube-shaped body. The at least one frictional element may comprise three arms evenly spaced around a perimeter of the removal end. The at least one arm may be angled at approximately 20-degrees to approximately 25-degrees from the interior wall of the tube-shaped body. The at least one arm may collapse towards the interior wall of the tube-shaped body when the removal end is pushed in an upward direction over the light bulb and expand back towards the central axis of the tube-shaped body when the at least one arm passes the cuff of the cover. The at least one arm may comprise a grab edge at or near an end of the at least one arm.

According to another aspect, the removal tool may have at least one slot extending from an exterior of the tube-shaped body to an interior of the tube-shaped body at or near the removal end; and the at least one slot receiving the at least one elastic. When the at least one elastic is within the at least one slot, the at least one elastic may form at least one chord around a circumference of the tube-shaped body. The removal end may comprise an inside diameter approximately 7-mm larger than the diameter of the light bulb.

According to yet another aspect, there is provided a tool for installing and removing a cover for a light bulb within a fixture. The tool may have a tube-shaped body with an installation end, a removal end, and a central axis along the tube-shaped body; a platform located within the tube-shaped body near the installation end; at least one frictional element on an interior surface of the removal end for engaging the cover; and a handle attachment selectably and rotatably coupled to an exterior of the tube-shaped body between the installation end and the removal end.

The tool may have a pair of pivots on opposite sides of the exterior of the tube-shaped body and located between the installation end and the removal end. The pair of the pivots may have an axis transverse to the central axis of the tube-shaped body. The pair of the pivots may receive a pair of rods extending generally parallel to the tube-shaped body; and the pair of rods couple to the handle attachment. Each of the rods may have a bend and an angled portion with the angled portion approaching the central axis of the tube-shaped body. The angled potions may couple to the handle attachment; and the handle attachment may be generally aligned with the central axis.

Each of the pivots may have a groove extending generally parallel to the central axis wherein the rods may rest in the grooves maintaining the rods in position along the tube-shaped body; and when the rods are pulled out of the grooves, then the rods may rotate about the pivots in order to change the tool from an installation configuration to a removal configuration and vice versa.

The tube-shaped body may form an interior storage; and a cutout from the exterior of the tube-shaped body to the interior storage. The cutout may be located between the pivots and the removal end. The cutout may be oval or circular-shaped; and may be sized to allow passage of the cover therethrough. The platform may be contoured to a shape of the cover.

The tube-shaped body may have a thickness sized so that the installation end fits between the light bulb and the fixture. A diameter of the installation end may be approximately 110% of a largest diameter of a light emitting end of the light bulb. The central axis of the tube-shaped body may be aligned with an axis of the light bulb; and the installation end may be pushed upward toward the light bulb until a cuff of the cover bypasses the largest diameter of the light bulb.

The at least one frictional element may be selected from at least one of: at least one arm, at least one wedge, at least one elastic, and any combination of the at least one arm, the at least one wedge, and the at least one elastic. The at least one frictional element may be integrally formed with the tube-shaped body. The at least one arm may be angled downward away from the removal end and along an interior wall of the tube-shaped body. The at least one frictional element may comprise three arms evenly spaced around a perimeter of the removal end. The at least one arm may be angled at approximately 20-degrees to approximately 25-degrees from the interior wall of the tube-shaped body. The at least one arm may collapse towards the interior wall of the tube-shaped body when the removal end is pushed in an upward direction over the light bulb and expand back towards the central axis of the tube-shaped body when the at least one arm passes the cuff of the cover. The at least one arm may comprises a grab edge at or near an end of the at least one arm.

The removal end may comprise at least one slot extending from an exterior of the tube-shaped body to an interior of the tube-shaped body; and the at least one slot receiving the at least one elastic. When the at least one elastic is within the at least one slot, the at least one elastic may form at least one chord around a circumference of the tube-shaped body. The removal end may have an inside diameter approximately 7-mm larger than the diameter of the light bulb. A diameter between the installation end and the removal end may be less than a diameter at the removal end and a diameter at the installation end. At least one indicator on the exterior of the tube-shaped body for indicating whether the tool may be in an installation configuration or a removal configuration.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1A is a perspective top view of a cover;

FIG. 1B is a perspective bottom view of the cover;

FIG. 1C is a perspective side view of an injection-molded cover;

FIG. 2 is a perspective side view of the cover on a light bulb

FIG. 3 is a perspective side view of a tool for installing and/or removing the cover;

FIG. 4 is a perspective top view of the tool for installing and/or removing the cover in an installation position;

FIG. 5 is a perspective side view of the tool for installing and/or removing the cover in a removal position;

FIG. 6 is a perspective bottom view of the tool demonstrating an installation of the cover;

FIG. 7 is a perspective top view of the tool showing a removal end of the tool;

FIG. 8 is a side view of a protrusion for removing the cover;

FIG. 9, is a top perspective view further showing the protrusions for removing the cover;

FIG. 10 is a perspective top view of the tool showing another aspect of the removal end of the tool;

FIG. 11 is an orthogonal projection of another protrusion for removing the cover;

FIG. 12 is a perspective view of the tool for removing the cover further showing an elastic for removing the cover; and

FIG. 13 is a perspective view of the tool for installing to cover further showing a curved platform.

### DETAILED DESCRIPTION

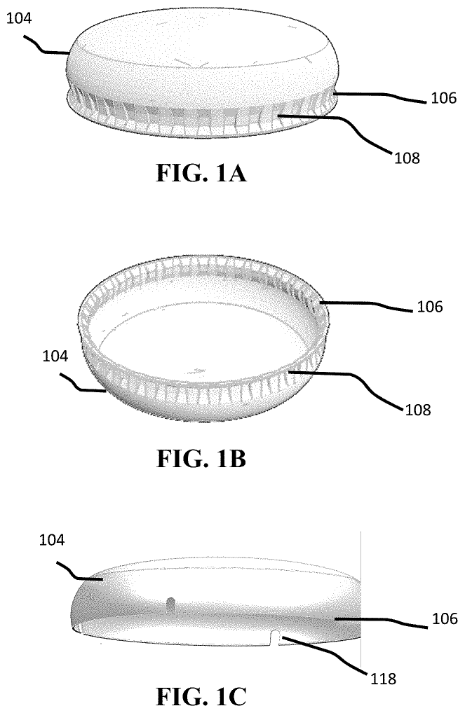

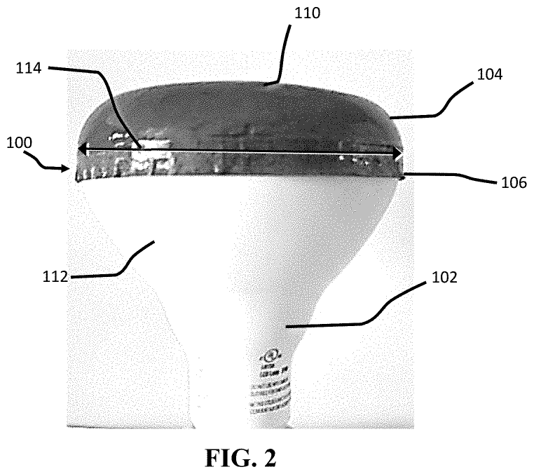

With reference to FIGS. 1A to 1C and 2, a cover 104 may be attached to a light bulb 102 in order to change a colour of light emitted by the light bulb 102. The aspects shown in FIGS. 1A, 1B, and 2 are of the cover 104 formed by a thermoforming vacuum machine. The aspect shown in FIG. 1C are formed by an injection-mold machine. When installed, the cover 104 and the light bulb 102 may be referred to as an installed configuration 100 as shown particularly in FIG. 2. In an aspect, the cover 104 may be provided in any colour such as red, green, blue, yellow, orange, and/or any combination thereof. However, the colours of the cover 104 are not intended to be limiting and any colour on the light spectrum may be used. The cover 104 may be a thin layer of a semi-transparent or translucent plastic. In some aspects, the plastic may only be suitable for low wattage bulbs such as light emitting diode bulbs. In other aspects, the plastic may be suitable for higher temperature bulbs, such as by using silicone rather than plastic. In the example provided herein, the cover 104 is constructed of Light Gels.

The cover 104 may be contoured to receive a light emitting end or face 110 of the light bulb 102. The cover 104 may extend partially onto a neck 112 of the light bulb 102 in order to maintain the cover 104 in position. The cover 104 may comprise a cuff 106 to facilitate maintaining the cover 104 on the light bulb 102. In this aspect, the cuff 106 may comprise a plurality of creases or indentations 108 around the cuff 106. In another aspect shown particularly in FIG. 1C, the cuff 106 may comprise one or more cutouts 118. When installing the cover 104, the cuff 106 may expand in order to fit over a larger diameter 114 of the light emitting end 110 and once the cuff 106 passes the light emitting end 110, the cuff 106 contracts around a smaller diameter of the neck 112 of the light bulb 102 thereby securing the cover 104 in place. When removing the cover 104, the cuff 106 similarly may expand in order to slide off of the light emitting end 110. When installed on the light bulb 102, the cuff 106 may secure the cover 104 in order to remain on the light bulb 102 in wind speeds of up to approximately 110 MPH.

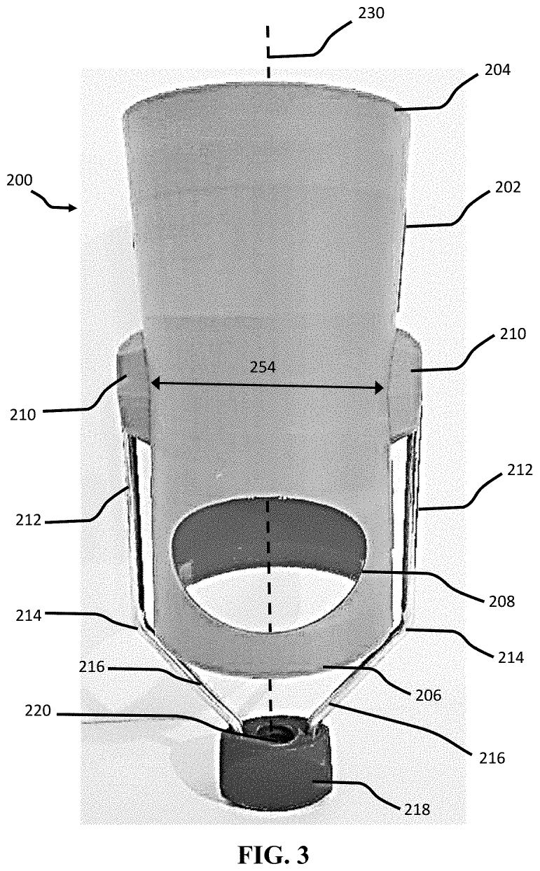

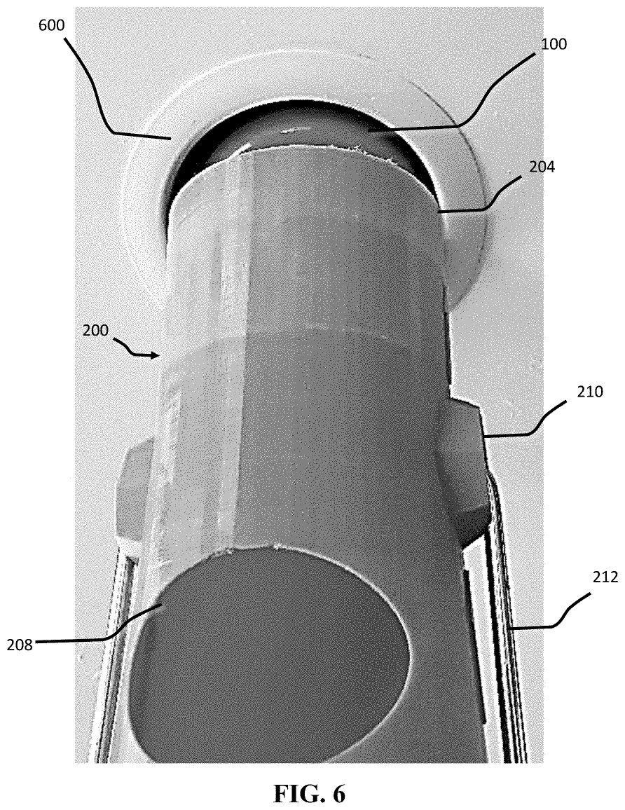

Turning to FIGS. 3 to 6, a tool 200 for installation and/or removal of the cover 104 is shown. In this aspect, the tool 200 may comprise a tube-shaped (or tubular) body 202 having an installation end 204 and a removal end 206. Other aspects may have only one of the installation end 204 or the removal end 206. The tube-shaped body 202 may be constructed of an injection molded plastic. A thickness 250 of the tube-shaped body 202 may be a minimal thickness so that the installation end 204 and the removal end 206 may fit between the bulb 102 and the fixture 600 as shown particularly in FIG. 6. On the exterior surface of the tube-shaped body 202 may be one or more indicators 240, 242 that indicate to an operator whether the tool 200 is in an installation configuration where the indicator 240 points in an upward direction or a removal configuration 206 where the indicator 242 points in a downward direction.

The tube-shaped body 202 may have a larger diameter 252 at the installation end 204 than the removal end 206. The diameter of the tube-shaped body 202 at each of the two ends 204, 206 may generally correspond to a diameter 114 of the light bulb 102. In some aspects, the diameter 254 between the two ends 204, 206 of the tube-shaped body 202 may be less than both the diameter at the two ends 204, 206. In some aspects, the diameter 254 at a position of a pair of pivots 210 may be at a minimum diameter for the tube-shaped body 202.

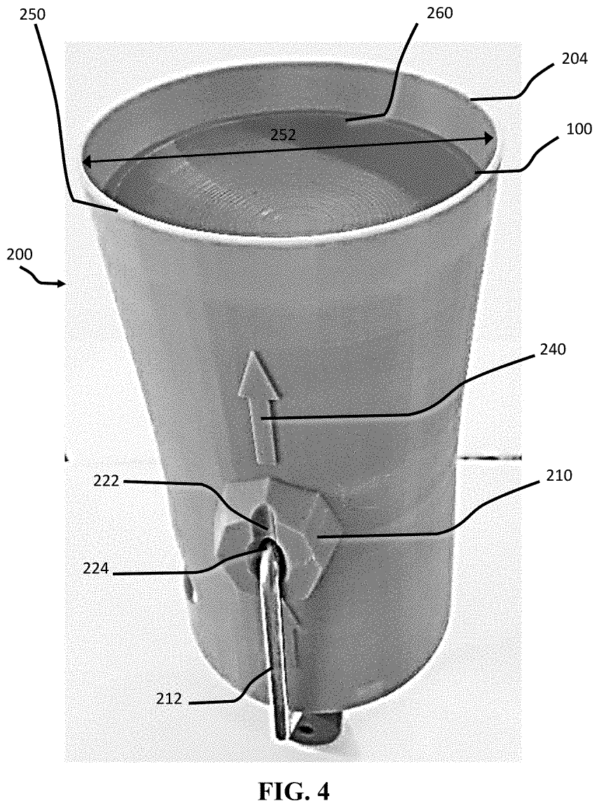

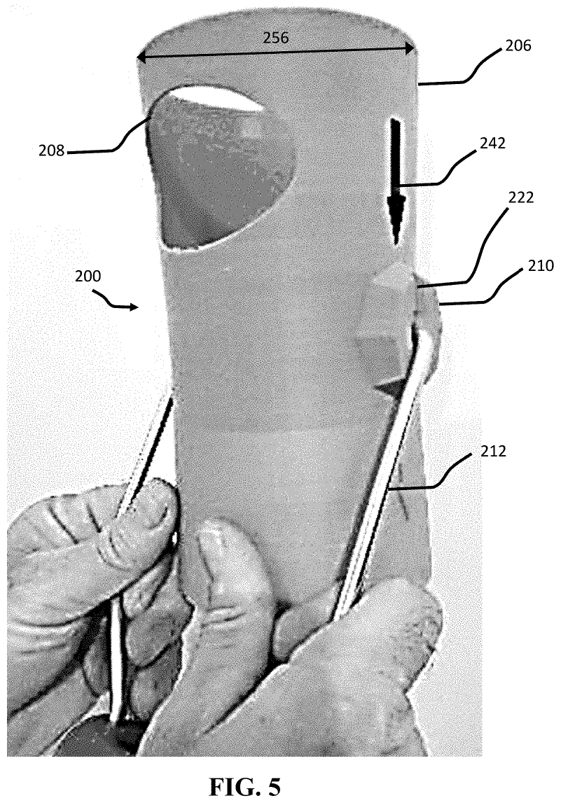

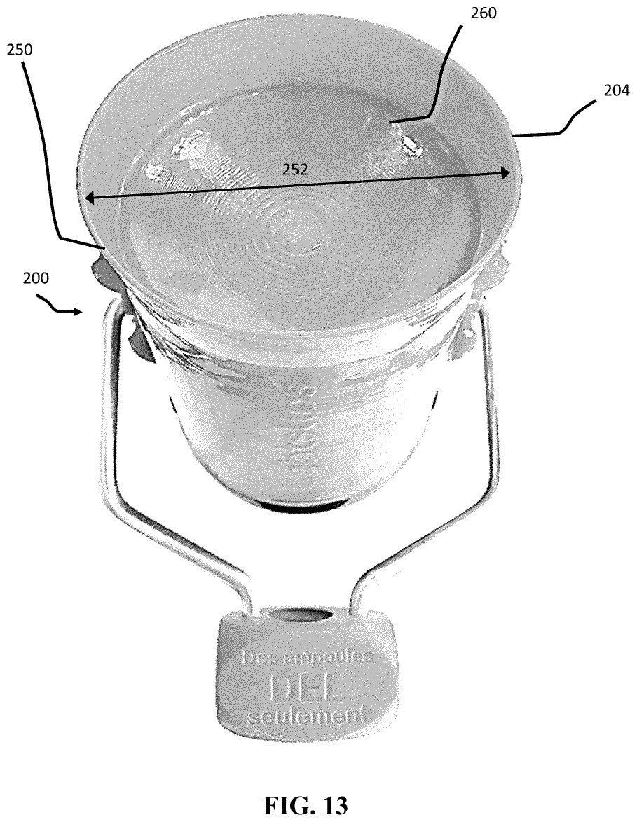

In this aspect shown particularly in FIGS. 4 and 13, an inside diameter 252 of the installation end 204 of the tube-shaped body 202 may be approximately of 110% of a largest diameter 114 of the light emitting end of the light bulb 102. The inside diameter 252 may permit a small amount of movement of the cover 104 once the tube-shaped body 202 starts to align or center on the light bulb 102. The inside diameter 252 of the installation end 204 being slightly larger than the largest diameter 114 of the light bulb 102 may allow the cuff 106 (e.g. the plurality of creases) to fit comfortably while the cuff 106 expands over the light bulb 102.

The cover 104 may rest on a platform 260 within the installation end 204. In this aspect the platform 260 may be located approximately a height of the cover 104 below the edge of the installation end 204 (e.g. approximately 20-mm for a BR30 bulb 102). This platform 260 may be contoured to generally match the contour of the cover 104. The contour of the platform 260 may provide a centering of the cover 104 within the tube-shaped body 202 and/or may provide a distributed force on the cover 104 to assist in sliding the cover 104 onto the bulb 102. The platform 260 may work in conjunction with the walls of the installation end 204 to push the cover 104 onto the light bulb 102.

During installation, the cover 104 may be placed on the platform 260 within the installation end 204. A central axis 230 of the tube-shaped body 202 may be aligned with the axis of the light bulb 102. The alignment of the central axis 230 and the axis of the light bulb 102 may reduce or prevent the cover 104 from falling off during high winds. The installation end 204 may then be pushed upward onto the light bulb 202 until the cuff 106 of the cover 104 bypasses the diameter 114 of the light bulb 102. In some aspects, installation of the cover 104 may be facilitated by applying pressure around the outer edge of the installation end 204, such as by using a handle.

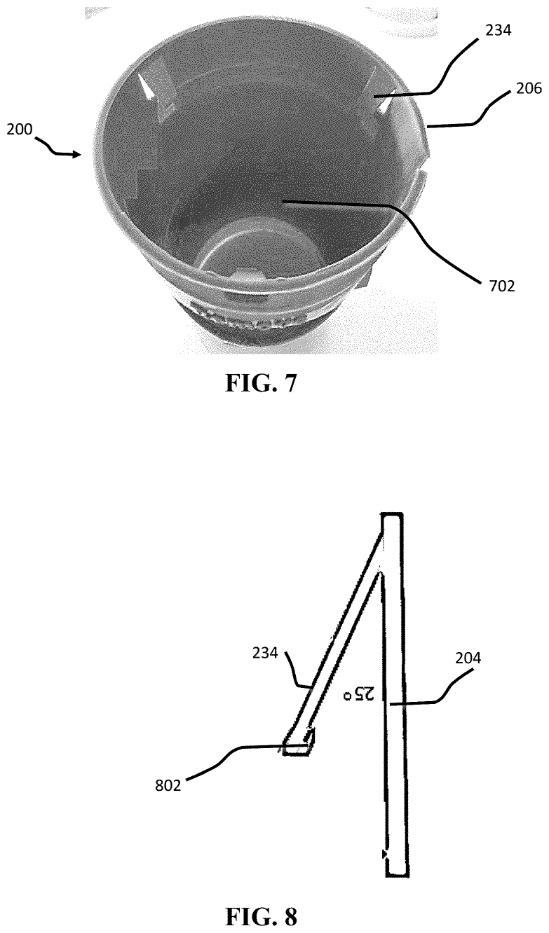

Turning to FIG. 5, the tool 200 is shown transitioning from the installation configuration to the removal configuration. As seen in FIG. 5, the tool 200 is nearly at the removal configuration. Similar to the installation end 204, the removal end 206 may have a thickness such that the removal end 206 may fit between the bulb 102 and the fixture 600. An inside diameter 256 of the removal end 206 may be approximately 7-mm larger than the diameter 114 of the face of the light bulb 102. This tolerance may allow for different types of removal configurations described with reference to FIGS. 7-12 below.

Generally, the removal end 206 may be placed over the light bulb 102 and cover 104 and one or more frictional elements on an interior surface of the removal end 206, such as arms 234, wedges 236, or elastics 270, may snag the cuff 106 of the cover 104 in order to remove the cover 104. The cover 104 may then fall into a cover storage 702 within the tubular body 202. The cover storage 702 may be a volume formed from the wall of the tube-shaped body 202 and the platform 260. The storage 702 may be sized to hold several covers 104 before filling the storage 702. In this aspect, the storage 702 may hold approximately 12 covers. In other aspects, the storage 702 may hold fewer or more covers depending on a size and/or a slope of a mold release angle. An oval or circular-shaped cutout 208 may be present through one side of the tube-shaped body 202 from the exterior of the tube-shaped body 202 to the storage 702 within the tube-shaped body 202. In this aspect, the cutout 208 may be located between the pair of pivots 210 and the removal end 206. The cutout 208 may facilitate easier removal of the covers 104 from the storage 702.

As shown particularly with reference to FIGS. 7 to 9, the arms 234 may be integrally formed of the same thermoplastic as the tubular body 202 or in other aspects, may be metal and may not be integrally formed with the tubular body 202. In this aspect, three arms 234 may be evenly spaced around the perimeter of the removal end 206. The arms 234 may be angled downward away from the opening of the removal end 206 at approximately 20 to 25-degrees from the walls of the tubular body 202. The arms 234 may be flexible and/or resilient such that when the removal end 206 is pushed in an upward direction over the light bulb 102 and the cover 104, the arms 234 collapse towards the walls for the tubular body 202 with little friction. Once the ends of the arms 234 pass the cuff 106, the arms 234 expand back towards the central axis 230 of the tubular body 202 to generally rest against the light bulb 102.

When the removal end 206 is pulled in a downward direction, the arms 234 may catch on the cuff 106 thereby pulling the cover 104 from the light bulb 102. In some aspects, each of the arms 234 may comprise one or more catches 802 (e.g. grab edge) in order to improve friction between the arms 234 and the cuff 106 when the tool 200 is pulled in a downward direction. As shown in FIG. 8, the catch 802 may be located on or near the end of the arm 234 on a surface between the arm 234 and the removal end 206 wall. The catch 802 may be a 2-mm edge that extends from or near the end of the arm 234 towards the wall of the removal end 206 at approximately 90-degrees.

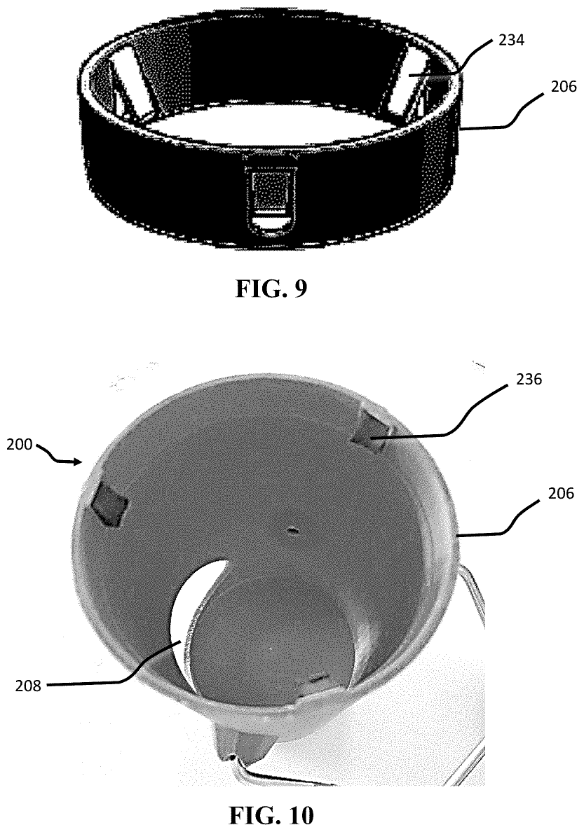

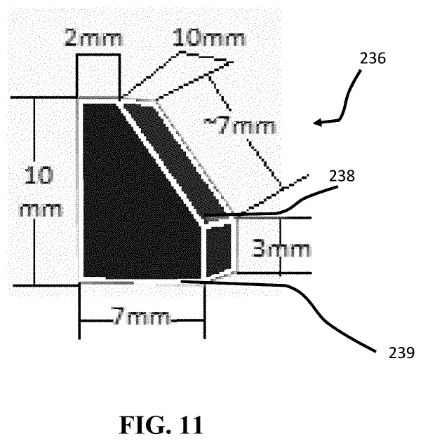

In another aspect shown particularly in FIGS. 10-11, the removal end 206 may comprise one or more wedges 236. In this aspect, three wedges 236 may be equally spaced around the interior of the removal end 206. In this aspect, the wedges 236 may be constructed of a flexible and/or resilient material, such as a sponge rubber. The operation of the wedge catches 236 is similar to that of the arm 234 and catches 802. The wedges 236 collapse against the walls of the removal end 206 when the tool 200 is pushed upward over the cover 104. Once pressed above the cuff 106 of the cover 104, the wedges 236 expand towards the light bulb 102. When the tool 200 is pulled downward, the wedges 236 may catch on the cuff 106 thereby removing the cover 104 from the light bulb 102.

When the tool 200 is pushed in an upward direction, the wedge 236 may provide a slope 238 the provides reduced friction with the cuff 106. Once the slope 238 passes the cuff 106, the wedge 236 may expand and a perpendicular surface 239 may engage the cuff 106. The perpendicular surface 239 may provide a higher friction than the reduced friction of the slope 238. In this aspect, the wedge 236 may be approximately 10-mm long with the perpendicular surface 239 being approximately 7-mm long. The slope 238 may be approximately 7-mm long.

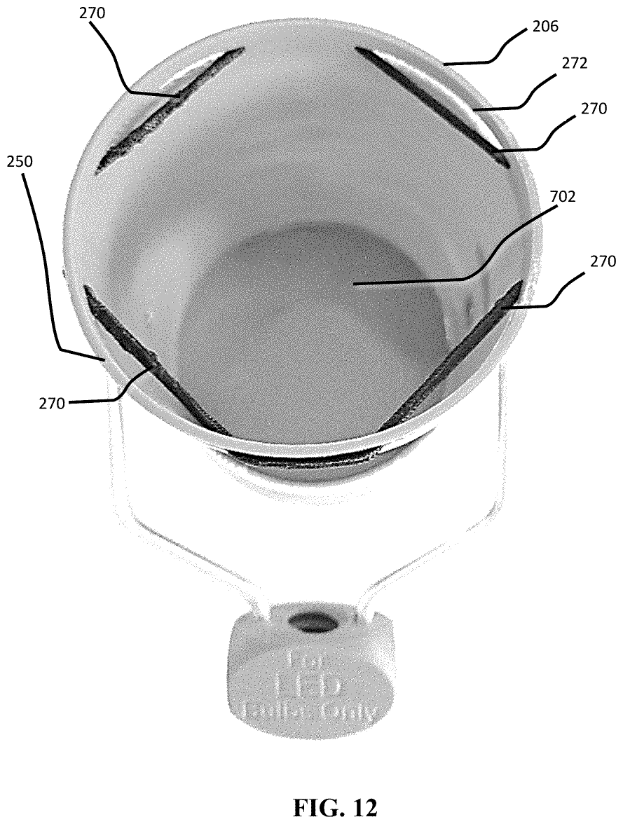

In another aspect shown particularly in FIG. 12, the removal end 206 may comprise at least one slot 272 (e.g. a plurality of slots 272) extending from an exterior of the tube-shaped body 202 to an interior of the tube-shaped body 202. The slots 272 may be generally aligned with each other around the circumference of the tube-shaped body 202 and may be located proximate to the removal end 206 of a distance less than the depth of the cover 104 from the removal end 206. These slots 272 provide an opening through the thickness 250 of the tube-shaped body 202 to receive the elastic 270. The elastic 270 may be placed on the outer circumference of the tube-shaped body 202 and may be received by the slots 272. In this configuration, the elastic 270 may form at least one chord (e.g. a plurality of chords) around the circumference of the tube-shaped body 202. In this aspect, four chords are shown but there may be fewer or more chords. The elastic 270 may be a braided elastic such as a braided nylon elastic.

Returning to FIG. 4, on an exterior of the tube-shaped body 202 may be the pair of pivots 210 having an axis generally perpendicular to the central axis 230 of the tube-shaped body 202. The pivots 210 may be located between the installation end 204 and the removal end 206. In this aspect, the pivots 210 may be approximately halfway between the installation end 204 and the removal end 206 and may be on opposing sides of the tube-shaped body 202. In this aspect, the pivots 210 may be generally octagonal prisms with a centrally located hole 224. The pivots 210 may receive a pair of rods 212 extending generally parallel to the tube-shaped body 202. The ends of the rods 212 received by the pivots 210 may be shaped to approximately 90-degrees in order to be received by the holes 224 in the pivots 210. Each of the pivots 210 may have a groove 222 extending generally parallel to the axis 230 of the tube-shaped body 202. The rods 212 may rest in the grooves 222 maintaining the rods 212 in position along the tube-shaped body 202. In this aspect, the rods 212 may be constructed of metal such as unthreaded zinc rods 212.

Returning to FIG. 3, once the rods 212 pass one of the ends 204, 206, each of the rods 212 may have a bend 214 and an angled portion 216 with the angled portion 216 approaching the central axis 230 of the tube-shaped body 202. The angled portions 216 may then be coupled to a handle attachment 218. The handle attachment 218 may be generally aligned with the central axis 230 of the tube-shaped body 202 and may be generally cylindrical in shape and constructed of plastic. A bore 220 may receive an extension pole, such as in this example, the bore 220 may be female threaded to receive a broomstick in order to reach light fixtures in a high area without use of a ladder (or in addition to a ladder).

In use, the handle attachment 218 may hold the rods 212 apart from each other at a distance such that a force or tension towards the central axis 230 of the tube-shaped body 202 may be experienced by the rods 212. The force may cause the ends of the rods 212 to be held within the centrally located holes 224 of the pivots 210 and the rods 212 may be aligned by the grooves 222. When the operator wishes to switch between the installation end 204 and/or the removal end 206 (or vice versa) as demonstrated particularly in FIG. 5, the operator may counteract the force towards the central axis 230 of the tube-shaped body 202 and may cause the rods 212 to exit the grooves 222 while maintaining the ends of the rods 212 within the holes 224. The rods 212 may then be freely rotated so that the handle attachment 218 is positioned at the opposite end and whereby the rods 212 may reenter the grooves 222.

Although particular shapes and/or number of the arms 234 and catches 802, 236 are described herein, these parameters may be varied depending on a size and/or a shape of the covers 104 and/or the light bulbs 102. In some aspects, a length and diameter of the tool 200 may also be varied accordingly with the size and shape of the cover 104 and/or the light bulb 102.

Although the platform 260 is demonstrated as a continuous surface in FIG. 4, other aspects may have the platform 260 with one or more holes therein. In some aspects, the platform 260 may be an annulus-shaped ledge around the interior of the installation end 204. In other aspects, the platform 260 may be perforated. The one or more holes may prevent or reduce any suction between the tool 200 and the cover 104 when the tool 200 is being removed after installing the cover 104.

Although the aspects described herein have the cuff 106 with a plurality of creases, other aspects may comprise an elastic used to retain the cover 104 on the light bulb 102.

Although the aspects described herein have a larger diameter 252 at the installation end 204 than the removal end 206, other aspects may have the larger diameter at the removal end 206 than the installation end 204. In some aspects, the removal end 206 and the installation end 204 may have similar diameters. The diameters of the ends 204, 206 may be determined, in part, by the diameter 114 and/or type of the light bulb 102.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention

What is claimed is:

1. A tool for installing a cover for a light bulb within a fixture, the tool comprising:
a tube-shaped body with an installation end and a central axis;
a platform located within the tube-shaped body approximately a height of the cover from the installation end; and
a handle attachment located near an opposite end of the installation end; the handle attachment receiving an extension pole.

2. The tool according to claim 1, wherein the platform is contoured to a shape of the cover.

3. The tool according to claim 1, wherein the tube-shaped body has a thickness sized so that the installation end fits between the light bulb and the fixture.

4. The tool according to claim 1, wherein a diameter of the installation end is approximately 110% of a largest diameter of a light emitting end of the light bulb.

5. The tool according to claim 4, wherein the central axis of the tube-shaped body is aligned with an axis of the light bulb; and the installation end is pushed upward toward the light bulb until a cuff of the cover bypasses the largest diameter of the light bulb.

6. The tool according to claim 1, further comprising a pair of pivots on opposite sides of the tube-shaped body with an axis transverse to the central axis of the tube-shaped body; the pair of the pivots receiving a pair of rods extending generally parallel to the tube-shaped body and couple to the handle attachment.

7. The tool according to claim 6, wherein each of the rods have a bend and an angled portion with the angled portion approaching the central axis of the tube-shaped body; and the angled portions couple to the handle attachment

8. The tool according to claim 7, wherein the handle attachment is generally aligned with the central axis of the tube-shaped body.

9. The tool according to claim 1, further comprising a removal end opposite to the installation end.

10. The tool according to claim 9, wherein the removal end comprises at least one frictional element on an interior surface of the removal end for engaging the cover.

11. The tool according to claim 10, wherein the at least one frictional element is selected from at least one of: at least one arm, at least one wedge, at least one elastic, and any combination of the at least one arm, the at least one wedge, and the at least one elastic.

12. The tool according to claim 9, further comprising an interior storage within the tube-shaped body.

13. A tool for removing a cover from a light bulb within a fixture, the tool comprising:
a tube-shaped body with an removal end and a central axis;
at least one frictional element on an interior surface of the removal end for engaging the cover; and
a handle attachment located near an opposite end of the removal end; the handle attachment receiving an extension pole.

14. The tool according to claim 13, further comprising an interior storage within the tube-shaped body; and the interior storage receiving at least one of the covers from the removal end.

15. The tool according to claim 14, further comprising a cutout from an exterior of the tube-shaped body to the interior storage; and the cutout is sized to allow passage of the cover therethrough.

16. The tool according to claim 13, wherein the at least one frictional element is selected from at least one of: at least one arm, at least one wedge, at least one elastic, and any combination of the at least one arm, the at least one wedge, and the at least one elastic.

17. The tool according to claim 13, wherein the at least one frictional element is integrally formed with the tube-shaped body.

18. The tool according to claim 16, wherein the at least one arm is angled downward away from the removal end and along an interior wall of the tube-shaped body.

19. The tool according to claim 16, wherein the at least one frictional element comprises three arms evenly spaced around a perimeter of the removal end.

20. The tool according to claim 18, wherein the at least one arm is angled at approximately 20-degrees to approximately 25-degrees from the interior wall of the tube-shaped body.

21. The tool according to claim 18, wherein the at least one arm collapses towards the interior wall of the tube-shaped body when the removal end is pushed in an upward direction over the light bulb and expand back towards the central axis of the tube-shaped body when the at least one arm passes the cuff of the cover.

22. The tool according to claim 18, wherein the at least one arm comprises a grab edge at or near an end of the at least one arm.

23. The tool according to claim 16, wherein the removal end comprises at least one slot extending from an exterior of the tube-shaped body to an interior of the tube-shaped body; and the at least one slot receiving the at least one elastic.

24. The tool according to claim 23, wherein when the at least one elastic is within the at least one slot, the at least one elastic forms at least one chord around a circumference of the tube-shaped body.

25. The tool according to claim 13, wherein the removal end comprises an inside diameter approximately 7-mm larger than the diameter of the light bulb.

26. A tool for installing and removing a cover for a light bulb within a fixture, the tool comprising:
a tube-shaped body with an installation end, a removal end, and a central axis along the tube-shaped body;
a platform located within the tube-shaped body near the installation end;
at least one frictional element on an interior surface of the removal end for engaging the cover; and
a handle attachment selectably and rotatably coupled to an exterior of the tube-shaped body between the installation end and the removal end.

27. The tool according to claim 27, further comprising a pair of pivots on opposite sides of the exterior of the tube-shaped body and located between the installation end and the removal end; the pair of the pivots having an axis transverse to the central axis of the tube-shaped body; the pair of the pivots receive a pair of rods extending generally parallel to the tube-shaped body; and the pair of rods couple to the handle attachment.

28. The tool according to claim 27, wherein each of the rods comprise a bend and an angled portion with the angled portion approaching the central axis of the tube-shaped body; the angled potions couple to the handle attachment; and the handle attachment is generally aligned with the central axis.

29. The tool according to claim 28, wherein each of the pivots comprises a groove extending generally parallel to the central axis wherein the rods may rest in the grooves maintaining the rods in position along the tube-shaped body; and when the rods are pulled out of the grooves, then the rods rotate about the pivots in order to change the tool from an installation configuration to a removal configuration and vice versa.

30. The tool according to claim 28, wherein the tube-shaped body forms an interior storage;
and a cutout from the exterior of the tube-shaped body to the interior storage.

31. The tool according to claim 31, wherein the cutout is located between the pivots and the removal end; wherein the cutout is oval or circular-shaped; wherein the cutout is sized to allow passage of the cover therethrough.

32. The tool according to claim 27, wherein the platform is contoured to a shape of the cover.

33. The tool according to claim 27, wherein the tube-shaped body has a thickness sized so that the installation end fits between the light bulb and the fixture.

34. The tool according to claim 27, wherein a diameter of the installation end is approximately 110% of a largest diameter of a light emitting end of the light bulb.

35. The tool according to claim 27, wherein the central axis of the tube-shaped body is aligned with an axis of the light bulb; and the installation end is pushed upward toward the light bulb until a cuff of the cover bypasses the largest diameter of the light bulb.

36. The tool according to claim 27, wherein the at least one frictional element is selected from at least one of: at least one arm, at least one wedge, at least one elastic, and any combination of the at least one arm, the at least one wedge, and the at least one elastic.

37. The tool according to claim 37, wherein the at least one frictional element is integrally formed with the tube-shaped body.

38. The tool according to claim 37, wherein the at least one arm is angled downward away from the removal end and along an interior wall of the tube-shaped body.

39. The tool according to claim 26, wherein the at least one frictional element comprises three arms evenly spaced around a perimeter of the removal end.

40. The tool according to claim 39, wherein the at least one arm is angled at approximately 20-degrees to approximately 25-degrees from the interior wall of the tube-shaped body.

41. The tool according to claim 37, wherein the at least one arm collapses towards the interior wall of the tube-shaped body when the removal end is pushed in an upward direction over the light bulb and expand back towards the central axis of the tube-shaped body when the at least one arm passes the cuff of the cover.

42. The tool according to claim 37, wherein the at least one arm comprises a grab edge at or near an end of the at least one arm.

43. The tool according to claim 37, wherein the removal end comprises at least one slot extending from an exterior of the tube-shaped body to an interior of the tube-shaped body; and the at least one slot receiving the at least one elastic.

44. The tool according to claim 44, wherein when the at least one elastic is within the at least one slot, the at least one elastic forms at least one chord around a circumference of the tube-shaped body.

45. The tool according to claim 26, wherein the removal end comprises an inside diameter approximately 7-mm larger than the diameter of the light bulb.

46. The tool according to claim 26, wherein a diameter between the installation end and the removal end is less than a diameter at the removal end and a diameter at the installation end.

47. The tool according to claim 26, further comprising at least one indicator on the exterior of the tube-shaped body for indicating whether the tool is in an installation configuration or a removal configuration.
